(19) United States
(12) Patent Application Publication
(10) Pub. No.: US 2003/0152822 A1
(43) Pub. Date: Aug. 14, 2003

(54) Fuel cell system with improved reaction gas utilization

(76) Inventors: Rolf Bruck, Bergisch Gladbach (DE); Joachim Grosse, Erlangen (DE); Jorg-Roman Konieczny, Siegburg (DE); Meike Reizig, Bonn (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/386,954

(22) Filed: Mar. 12, 2003

Related U.S. Application Data
(63) Continuation of application No. PCT/DE01/03319, filed on Aug. 29, 2001.

(30) Foreign Application Priority Data
Sep. 12, 2000 (DE) 100 45 098.9

(51) Int. Cl. H01M 8/02; H01M 8/10; H01M 8/24

(52) U.S. Cl. 429/38; 429/32

(57) ABSTRACT

A fuel cell unit with a fuel cell stack exhibits improved reaction gas utilization by defining variable mass transfer coefficients within the stack. The reaction gas utilization is optimized by matching and shaping the process gas stream distribution channels, such that the laminar flow in the smooth channels is turned into a turbulent flow and thus an increase in the mass transfer coefficient β in the back end of the stack occurs. According to a preferred embodiment, pole plates, tripping edges and deflectors are provided in the distribution channels. These measures allow the main direction of flow may be diverted to the active cell surfaces.

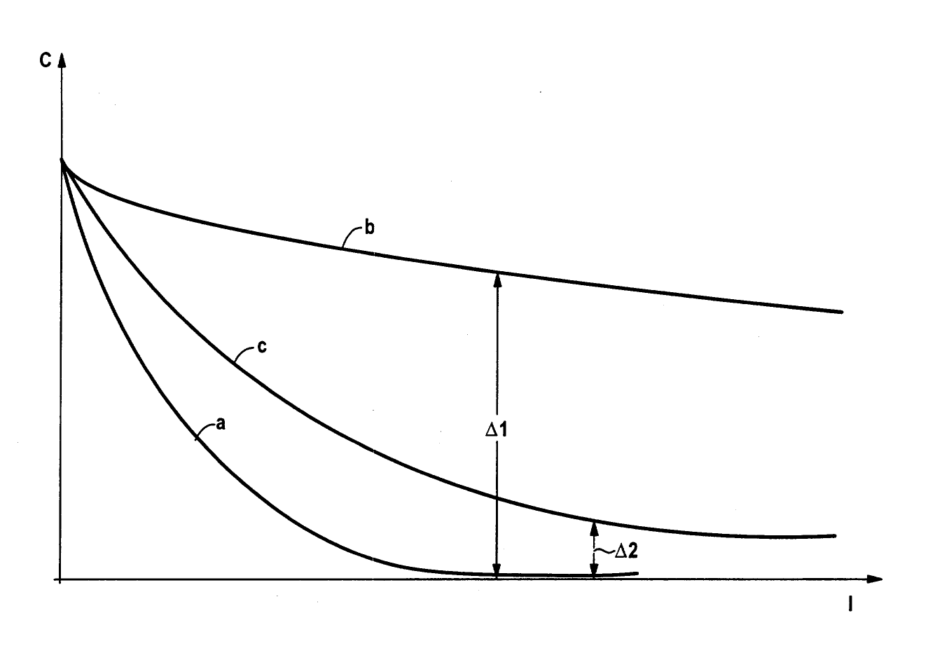

### CROSS-REFERENCE TO RELATED APPLICATION

This application is a continuation of copending International Application No. PCT/DE01/03319, filed Aug. 29, 2001, which designated the United States and was not published in English.

### BACKGROUND OF THE INVENTION

### FIELD OF THE INVENTION

The invention lies in the fuel cell technology field. More specifically, the invention relates to a fuel cell system with improved utilization of the reaction gas in the process gas, including a fuel cell stack through which the process gas flows.

A fuel cell stack comprises a plurality of fuel cell units. Process gas, which does not necessarily have to consist of 100% reaction gas but initially still contains high levels of reaction gas, e.g. hydrogen/oxygen, is consumed within a fuel cell stack. Therefore, it is converted into a process gas with a lower level of reaction gas and a higher level of exhaust gas/product water. This is due to the fact that on the active cell surface of each individual fuel cell unit reaction gas is released to the gas diffusion layer of the electrode and on the cathode side product water from the gas diffusion layer of the electrode is taken up by the process gas stream.

International PCT publication WO 00/02267 discloses a PEM fuel cell system having a fuel cell stack comprising individual fuel cell units each with a membrane electrode assembly (MEA), in which lines for coolant, which directly follow the lines for process gas, are introduced into the separators between the individual fuel cell units. Furthermore, German published patent application DE 198 35 759 A1 discloses a fuel cell in which obstacles which swirl up the operating media are provided in the flow field in the fuel chambers. In this context, in particular a velocity component in the direction of the electrode surface is imparted to the flowing process gas. A similar effect is achieved in the context of Japanese patent application JP 63-190255 A, in which locally turbulent flows are produced in the flowing fluids.

The depletion in the levels of reaction gas and the enrichment in the levels of exhaust gas/product water in the process gas stream takes place at the outer flow interfaces, and consequently the deterioration in the reaction gas is not constant across the cross section of flow, but rather is less in the center of the flow than in the edge region of the flow. The only factor counteracting this is that transfer flows run transversely to the main direction of flow within a laminar flow as prevails in conventional distribution passages of fuel cell stacks, the momentum of which transfer flows is, for example, diffusion, and these transfer flows move the reaction gas out of the center of the flow into the edge region of the flow.

The mass transfer resulting from the latter transfer streams is determined by two variables, namely the surface area and the momentum, the momentum increasing marginally in the direction of flow, on account of the increasing depletion, whereas the surface area, which has a decisive influence on the exchange of fluid from the center of flow to the edge region, remains constant since the cross section of the distribution passages remains identical. This means that the mass transfer coefficient β, which can be regarded as a measure of the exchange of fluid particles from the center of flow and from the edge of the flow, is virtually constant within a stack. The effect of the resulting exchange is altogether inadequate to be able to compensate for the depletion of reaction gas in the flow edge region, the extent of which increases in the direction of flow. The active cell surfaces in the rear region of a fuel cell stack therefore often have process gas which has only a small residual reaction gas concentration in the flow edge region flowing over it, and have a decreasing effectiveness and a decreasing efficiency.

To create better-performing stacks with a higher effectiveness for stationary use and with a lower volume/weight, in particular for mobile use, it is important to further optimize the utilization of the reaction gas in the stacks.

### SUMMARY OF THE INVENTION

It is accordingly an object of the invention to provide a fuel cell configuration with improved reaction gas utilization which overcomes the above-mentioned disadvantages of the heretofore-known devices and methods of this general type and which provides for higher-performance, more effective stacks with an improved utilization of reaction gas, so that a maximum amount of reaction gas from the process gas is made available to the active cell surfaces.

With the foregoing and other objects in view there is provided, in accordance with the invention, a fuel cell system with improved utilization of reaction gas in a process gas, comprising:

a fuel cell stack having at least one fuel cell with an active surface and conducting the process gas along a direction of flow, wherein a transfer stream acting on the active surface of the fuel cell is determined by a mass transfer coefficient;

the mass transfer coefficient in the transfer stream perpendicular to the direction of flow of the process gas being variable (variable transverse flow may be effected, for example, by a variation in a cross section and/or a structure and form of the distribution passage), and the transfer stream increasing in the direction of flow of the process gas.

Preferably, the fuel cell stack comprises a plurality of PEM fuel cell units or a plurality of HT-PEM fuel cell units.

In accordance with an added feature of the invention, the fuel cell stack has a process gas supply for at least two fuel cell units. Each process gas supply comprises a membrane having two sides each with an electrode coating and at least one terminal plate delimiting the fuel cell unit and forming distribution passages for distribution of the process gas over the active cell surface, and wherein at least one distribution passage of a respective the terminal plate is adapted, in terms of an arrangement thereof within the fuel cell stack, to define a distribution passage with a [more or less strong] variable transverse flow in the process gas flow in dependence on an extent to which the process gas impinging thereon has been consumed.

In accordance with an additional feature of the invention, a distribution passage is formed with at least one structure for diverting the direction of flow of at least some of the process gas onto the active cell surface.

In accordance with another feature of the invention, at least some of the flow is conducted to flow through the electrode coating. Additionally, the structure of at least one distribution passage may be formed with tripping edges. Also, the structure of at least one distribution passage may be formed with longitudinal and/or transverse structures.

In accordance with a concomitant feature of the invention, at least one distribution passage is formed with an altered passage cross section.

In other words, the invention provides for a fuel cell stack with a variable mass transfer coefficient β of the transfer stream perpendicular to the direction of flow of the process gas. In this context, the term “variable” is to be understood as meaning that not only does the coefficient β change as a result of the concentration gradient within the cross section of flow, but also, as a result of turbulence and/or diversions being created in the flow, the surface area which the transfer stream has to flow through in order to achieve exchange between the center of the flow and the edge region of the flow is varied.

In the invention, the distribution passages advantageously have structures, such as tripping edges and diversion means, by which the main direction of flow of the process gas is diverted toward the active cell surface.

The invention is particularly suitable for implementation in PEM fuel cells or HT-PEM fuel cells. These are fuel cells which operate with proton exchange (Proton Exchange Membrane) and have a polymer electrolyte membrane. It is advantageous for it to be possible for fuel cells of this type to be operated at temperatures of between 60 and 300° C., with the range above 120° C. being classified as that of a HT-PEM fuel cell.

Further advantages and details of the invention will emerge from the following description of exemplary embodiments in conjunction with the patent claims. Reference is made to the structure of known fuel cell units which have been modified in order to achieve a variable mass transfer coefficient in the transfer stream perpendicular to the direction of flow of the process gas. The targeted influencing of the mass transfer resistance is of crucial importance in this context.

The mass transfer coefficient β can be altered by changing the laminar flow which prevails in the distribution passages into a turbulent flow. By way of example, this is achieved by means of structures which divert parts of the flow, produce a transverse flow and/or generate turbulence within the distribution passages. In this context, in a cross-sectional plane of a distribution passage through which process gas flows, either parts of the outer flow are diverted inward and/or parts of the inner flow are diverted outward and are in this way mixed. Structures for distribution passages which are suitable for this purpose are known from international PCT publications WO 91/01807 A1 (U.S. Pat. Nos. 5,045,403 and 5,130,208), WO 96/09892 A1, WO 91/01178 A1 (U.S. Pat. Nos. 5,403,559), and 5,902,558 specifically for catalytic converter systems. The contents of those publications, with a view to adapting their teachings specifically for the structures at hand, are herewith incorporated by reference. The structures can adopt different angles with respect to the outer wall of the distribution passages, angles of between 20° and 90° with respect to the main direction of flow, in particular angles of between 30° and 60°, being preferred.

The structures may therefore be simple elevations, such as for example the abovementioned “tripping edges” within the passage, resulting in the formation of turbulence in the flow. This results in an increase in the Reynolds number and therefore an improved mass transfer and exchange of fluid particles between the center of the flow and the edge region of the flow.

The term tripping edge is used as a general term to indicate a bulge, which may be either shallow or steep, thick or thin, pointed, curved or round, etc., and according to the invention all variants of flow obstacles can be implemented. The height and shape of the edge determines the extent of deviation and may vary within the stack and even within the fuel cell unit, so that the structuring of the distribution passages of the stack can be matched even to minor changes in concentration.

Structures which can be used to vary the mass transfer and by means of which at least parts of the process gas flow can be diverted and/or made turbulent are, for example, transverse and/or longitudinal structures which are described in detail by the publication SAE Technical Paper Series No. 950788 by one of the inventors, entitled “Flow Improved Efficiency by New Cell Structures in Metallic Substrates”. The SAE paper also forms a part of the disclosure with regard to the novel application and it is herewith incorporated by reference.

When choosing the geometry of the structure for creating diversion and/or generating turbulence, the pressure loss which is formed in the process gas stream and has an adverse effect on the efficiency is balanced against the improved utilization of the reaction gas present in the process gas which is effected by the diversion and a choice is made with a view to optimizing efficiency in the stack.

By means of design measures carried out at the distribution passage, the change in the mass transfer coefficient β can be designed in such a way that the result is a mass transfer which increases in the direction of flow. As a result, the reaction gas depletion in the edge region of flow of the process gas is at least partially compensated for.

In the invention, it is possible for the diversions in the distribution passage to be arranged in such a way that they divert the main direction of flow of the process gas onto the active cell surface, so that, contrary to what has hitherto been the case, the process gas does not flow over the active cell surface, but rather flows onto the active cell surface and in this way a significantly improved occupancy and utilization of the reactive spaces in the gas diffusion layer is achieved. As a result, the process gas flow is forced to at least partially flow through the electrode coating.

In a further configuration of the invention, a narrowing in the cross section of the distribution passages can be used to change the mass transfer coefficient β, so that—even without further structures being formed—the reaction gas utilization in the rear part of the stack is optimized in the distribution passage. The narrowing may also be effected periodically, so that a smaller cross section is followed by a larger cross section and vice versa and, by way of example, the mean flow rate does not increase. In an advantageous configuration of the periodic narrowing, the narrowing of one passage corresponds to and effects the widening of an adjacent passage, and vice versa.

In the rear region of the stack, a large distribution passage cross section on the cathode side is generally advantageous, since there the volume of the process gas increases on account of the uptake of 2 mol of water for only one mole of oxygen. At the same time, a general narrowing of the anode-side distribution passage cross section may be advantageous, since hydrogen is consumed there. It is advantageous to change the passage cross section.

The “rear region” of a stack denotes that or those fuel cell unit(s) in which the concentration of reaction gas in the process gas, in particular in the outer flow edge region, asymptotically approaches zero, so that good utilization of the active cell area, i.e. of the reaction spaces in the gas diffusion layer, is no longer ensured. This region also corresponds to the passage end.

The term “structure of a distribution passage” is understood as meaning its formation on the inner side, i.e. on the surface which has a direct influence on the process gas flow in the passage.

The term “process gas” is understood as meaning the fluid which is introduced into the fuel cell stack in order to be reactive on the active cell surface, and it comprises at least a proportion of reaction gas and may also include inert gas, product water (in liquid and/or gas form) and other constituents.

The term “fuel cell stack” is understood as meaning a stack comprising at least two fuel cell units, preferably polymer electrolyte membrane (PEM or HT-PEM) fuel cell units (standard or strip cells), which comprise process-gas supply passages, in each case one membrane with an electrode coating on both sides and at least one terminal plate for delimiting the fuel cell unit and for forming distribution passages for distributing the process gas over the active cell surface.

The term “fuel cell unit” is understood as meaning both a conventional fuel cell, i.e. with a large-area membrane, and what is known as a “strip cell unit”, which has a small membrane surface.

According to the invention, at least one distribution and/or supply passage of a fuel cell unit is matched, in terms of its arrangement within the stack, in such a way that the cross section and/or structure and shape of the distribution passage effects greater or lesser turbulence in the process gas flow as a function of the extent to which the process gas impinging on it has been consumed.

The periodic offset in the gas diffusion layer can also produce contact between the gas diffusion layer and the inner flow of the process gas. In this context, it should be ensured that the electrical contact within the gas-conducting layer must not be broken.

Other features which are considered as characteristic for the invention are set forth in the appended claims.

Although the invention is illustrated and described herein as embodied in a fuel cell system with improved reaction gas utilization, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE is a graph plotting three curves a), b) and c) of a process gas concentration over a length of the distribution channel.

### DESCRIPTION OF A PREFERRED EMBODIMENT

Referring now to the single FIGURE of the drawing in detail, there are shown three curves a), b) and c) which show the decrease in the concentration [C] of reaction gas in the process gas stream over a length l of the distribution passage. The length l of the distribution passage is plotted on the x axis, and the concentration [C] of reaction gas is plotted on the y axis.

The curve a) shows the decrease in the amount of reaction gas in the flow edge region, which is identical according to the prior art and according to the invention, since the invention effects the improvement of the reaction gas utilization from the center of the flow. The utilization of reaction gas in the flow edge region in accordance with curve a) is in any case optimal, since it asymptotically approaches the concentration zero, as the flow edge region comes into contact with the reaction spaces which are to be occupied in the gas-conducting layer. The situation is different for the center of flow, which according to the prior art (i.e., generally round distribution passages without an internal structure and with a constant cross section), shows scarcely any drop in the concentration of reaction gas over the length of the distribution passage. The prior art structural configuration thus is reflected, inter alia, in the high percentage of reaction gas in the fuel cell exhaust gas. By way of example, the anode exhaust gas may contain up to 17% of hydrogen. This is unused fuel, resulting in an unnecessarily high fuel consumption.

In the FIGURE, curve b) shows a concentration overhang. This concentration overhang in the center of the flow, which still exists even at the end of the passage, is specially marked by the distance Δ1 and should be minimized, so that only a small amount of reaction gas leaves the stack with the exhaust gas.

In this context, the FIGURE also shows curve c), which shows a reaction gas concentration drop in the center of flow for a passage according to the invention, which has a variable mass transfer coefficient β perpendicular to the direction of flow.

The Δ in curve c), i.e. the concentration difference Δ2 within the cross section of flow for a novel distribution passage according to the invention, is in this case significantly lower than in the prior art. There, considerable amounts of fuel can be saved.

The invention therefore optimizes the reaction gas utilization by adapting and structuring the distribution passages of the process gas stream, so that the laminar flow of the smooth passages is converted into a turbulent flow, and as a result the mass transfer coefficient β is increased in the direction of flow.

The latter factor is particularly advantageous for PEM or HT-PEM fuel cells. If, in these fuel cells, tripping edges and/or diversions are provided in the distribution passages of the terminal plates, the main direction of flow is diverted onto the active surface of the fuel cell.

We claim:

1. A fuel cell system with improved utilization of reaction gas in a process gas, comprising:
a fuel cell stack having at least one fuel cell with an active surface and conducting the process gas along a direction of flow, wherein a transfer stream acting on said active surface of said fuel cell is determined by a mass transfer coefficient;
said mass transfer coefficient in the transfer stream perpendicular to the direction of flow of the process gas being variable, and the transfer stream increasing in the direction of flow of the process gas.

2. The fuel cell system according to claim 1, wherein said fuel cell stack comprises a plurality of PEM fuel cell units.

3. The fuel cell system according to claim 1, wherein said fuel cell stack comprises a plurality of HT-PEM fuel cell units.

4. The fuel cell system according to claim 1, wherein said fuel cell stack has a process gas supply for at least two fuel cell units and comprises a plurality of PEM fuel cell units or HT-PEM fuel cell units, each process gas supply comprises a membrane having two sides each with an electrode coating and at least one terminal plate delimiting said fuel cell unit and forming distribution passages for distribution of the process gas over said active cell surface, and wherein at least one distribution passage of a respective said terminal plate is adapted, in terms of an arrangement thereof within said fuel cell stack, to define a distribution passage with a [more or less strong] variable transverse flow in the process gas flow in dependence on an extent to which the process gas impinging thereon has been consumed.

5. The fuel cell system according to claim 4, wherein a distribution passage is formed with at least one structure for diverting the direction of flow of at least some of the process gas onto said active cell surface.

6. The fuel cell system according to claim 4, wherein at least some of the flow is conducted to flow through said electrode coating.

7. The fuel cell system according to claim 4, wherein said structure of at least one distribution passage is formed with tripping edges.

8. The fuel cell system according to claim 4, wherein said structure of at least one distribution passage is formed with at least one structure selected from the group consisting of a longitudinal structure and a transverse structure.

9. The fuel cell system according to claim 4, wherein at least one distribution passage is formed with an altered passage cross section.

10. The fuel cell system according to claim 4, wherein the variable transverse flow is effected by a variation in a cross section or a structure and form of said distribution passage.
